(19) United States
(12) Patent Application Publication
(10) Pub. No.: US 2016/0246312 A1
(43) Pub. Date: Aug. 25, 2016

(54) CLOUD COMPUTING ENABLED BUILDING CONTROL SYSTEM AND METHOD

(71) Applicants: Matthew Toddy, Avon Lake, OH (US); Kevin McManamon, Avon Lake, OH (US)

(72) Inventors: Matthew Toddy, Avon Lake, OH (US); Kevin McManamon, Avon Lake, OH (US)

(21) Appl. No.: 14/626,870

(22) Filed: Feb. 19, 2015

(51) Int. Cl. G05D 23/13; G05B 19/042

(52) U.S. Cl. CPC G05D 23/1393; G05B 19/042; G05B 2219/2614

(57) ABSTRACT

The present invention is a building control system and method that comprises a first and second database where the first database is located remotely from the building control system and is synchronized with the second database which is located within the control system. The second database is used by the building control system to store configuration data and building system state data. The first database may be used to store preconfigured characteristics of a building control system before installation of the building control system. The present invention may also comprise a license database that provides license codes to the building control system where the building control system defaults to a minimum performance configuration if the building control system does not receive a valid code from the license database.

### TECHNICAL FIELD

Exemplary embodiments of the present invention relate generally to networked systems to monitor and control various building systems, such systems being configured to allow remote monitoring and control.

### BACKGROUND AND SUMMARY OF THE INVENTION

Building control systems may comprise inputs and outputs that control various building functions. These functions commonly include heating/cooling and lighting. Building control systems may be used to increase occupant comfort, provide security, reduce operating costs, or to prevent damage to the building or its contents. The simplest building control systems are mechanical thermostat devices that are used to regulate building temperature. Over time, these mechanical devices developed into complex systems that incorporated sensors to detect temperature at various locations throughout a building. In addition to multiple sensing locations, these devices also incorporated mechanisms designed to account for the time required by the heating or cooling device to reach an optimum temperature for heating or cooling. This adaptation allowed the building control system to better regulate building conditions. In addition to adaptations to improve the system's ability to regulate building conditions, other adaptations were made to accommodate the various building systems being controlled. For example, certain heating systems have a heating component (for example, a boiler) and a separate component for distribution of the heat (for example, a pump). While such configurations provided additional control functionality, the additional involvement of the controller in the operation of the devices they also required that the controller be able to accommodate the specific requirements of various systems and manufacturers. Other embodiments of building control systems have incorporated a timer to control or modify the operation of the various controlled elements. For example, a thermostat may use a timer to set a lower heating temperature during periods of time when a building is not normally occupied. As computerized control devices became available, such devices were adapted to perform building control operations. Such devices were equipped with input and output connections that could be configured to receive inputs and provide outputs used to control building and systems.

As computerized control systems became more capable and sophisticated, they also became more difficult to install and configure. For example, each input and output used by a control required programming to configure the input or output for its intended use. This programming required that the input or output be determined prior to installation of the controlling device so that the device could be configured for installation. With the advent of wide area networks such as the internet, programmable control devices were equipped with communications interfaces such that status information could be made available at remote locations. These communications interfaces could also be used for remote diagnostics and control.

Known control systems are costly to purchase and install. This is the direct result of the increasing complexity of the control hardware and software required to implement a building control system. In particular, a builder, other installer, or end user may desire the benefits of a building control system but be unable to afford the initial purchase and installation cost of such a system. What is needed is a system that enables a reduced level of installation and setup cost as well as a system that enables a control-as-a-service approach to system pricing.

An embodiment of the present invention may be implemented with a programmable hardware device that has remotely configurable input and output interface connections. Such an embodiment may be configured using a system that creates a virtual controller which may be programmed to configure characteristics of a controller's input and output interface connections. The configuration as well as programming that cause the inputs and outputs to perform various functions may be configured and stored using the virtual controller. In embodiments of the invention, the configuration may be stored in a database that is then transferred or synchronized with the actual controller when it is installed. Such an embodiment may allow a builder or other installer to maintain an inventory of non-configured hardware which can be configured remotely after installation. An additional advantage of such an embodiment is that configuration may be performed centrally by a person or organization that is well versed in such programming, allowing for a more cost effective and efficient programming process.

Embodiments of the invention may also be configured to require periodic renewal of an operating license. In such an embodiment, an installed building control system may require periodic renewal of a license “key” that is provided by a remote license server or similar system. In such an embodiment, a building control system may periodically request an updated license from the license server. In the event that an updated license is not supplied, the building control system may be configured such that it will revert to a default control state for the various controlled building systems. For example, a building climate control implementation may revert to a fixed temperature setting of 68 degrees Fahrenheit. Such a fixed temperature may avoid building damage while encouraging an end-user to pay a subscription fee to gain the energy savings and additional comfort available from a fully controlled system. Such an embodiment may facilitate the provisioning of building control as a recurring service fee rather than a capital expenditure.

Embodiments of the invention may be configured to be “cloud based”, that is, using a database of system configuration and status parameters that is remote from the building control hardware. As a result, configuration and status information may be retrieved without requiring the person or entity performing the configuration to have direct access to the computer network to which the building control system is connected. Embodiment of the invention may also implement tunnel or virtual private network techniques in order to avoid allowing the building control hardware to have access to other devices and systems connected to the network. In such an embodiment, a user may connect the building control hardware to the network and then subsequently access the building control hardware without the requirements of network permissions or network firewall reconfiguration.

### BRIEF DESCRIPTION OF THE DRAWINGS

In addition to the features mentioned above, other aspects of the present invention will be readily apparent from the following descriptions of the drawings and exemplary embodiments, wherein like reference numerals across the several views refer to identical or equivalent features, and wherein:

FIG. 1 is a block diagram of a building controller according to an embodiment of the invention;

FIG. 2 is a block diagram of embodiment of the invention illustrating a controller in communication with external databases, a local user, a remote user, and various building functions;

FIG. 3 is a block diagram illustrating an embodiment of the invention illustrating the interaction between a system database, a scheduler database, a script scheduler, and the several exemplary control scripts;

FIG. 4 is a user interface illustrating an embodiment of the invention;

FIG. 5 is a flowchart illustrating an embodiment of the operating script;

FIG. 6 is a user interface illustrating an embodiment of the invention;

FIG. 7 is a flowchart illustrating an embodiment of the synchronization process;

FIG. 8 is a user interface illustrating an embodiment of the invention;

FIG. 9 is a block diagram of embodiment of the invention illustrating a configuration in which a user may have access to a plurality of building controllers; and

FIG. 10 is a flowchart illustrating an embodiment of the license renewal process.

### DETAILED DESCRIPTION OF EXEMPLARY EMBODIMENT(S)

Various embodiments of the present invention will now be described in detail with reference to the accompanying drawings. In the following description, specific details such as detailed configuration and components are merely provided to assist the overall understanding of these embodiments of the present invention. Therefore, it should be apparent to those skilled in the art that various changes and modifications of the embodiments described herein can be made without departing from the scope and spirit of the present invention. In addition, descriptions of well-known functions and constructions are omitted for clarity and conciseness.

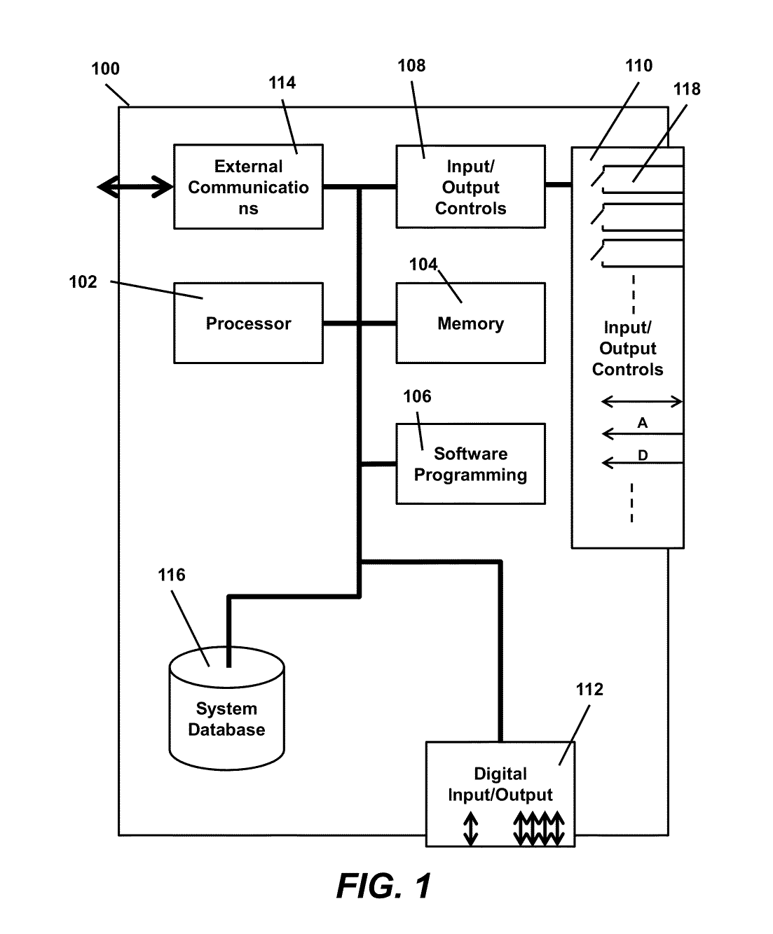

An example of the controller hardware utilized in an embodiment of the invention is illustrated in FIG. 1. As is shown, a building controller 100 may comprise a processor 102, a memory 104, operating software 106, Input/output (I/O) control circuitry 108 and I/O hardware 110, building device communication interfaces 112, external communication interface hardware 114, and a local database 116. Embodiments of the invention may also comprise user interface devices such as text or graphic displays and various indicators. Embodiments may also comprise user input devices such as pushbuttons, switches, or touch screen interface devices.

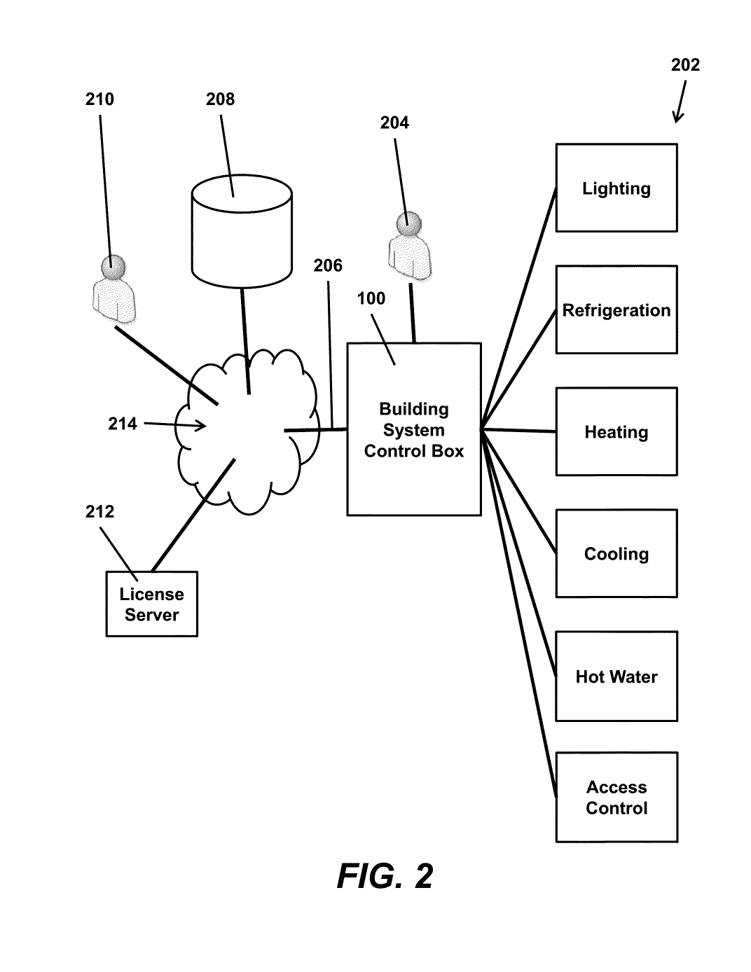

FIG. 2 illustrates an example embodiment of the building controller 100 hardware in communication with building devices 202, a local user 204 and a connection to the internet 206. Also illustrated are a cloud database 208, a remote user 210, and a licensing server 212. The license server may also comprise a license database. In an exemplary embodiment, a local user 204 may communicate with the building controller 100 using a physical interface integrated into the controller box or using a computer device such as a laptop or tablet computer or smart phone to communicate with the controller box through the use of a computer network to which the controller is in electronic communication. The remote user 210 and the local user 204 may communicate to the building controller 100 using an internet connection 214. In order to limit the vulnerability of such a connection to unauthorized users, a secure connection may be formed through the use of techniques such as secure tunnel or virtual private network (VPN) connections, which the building controller 100 hardware itself-initiates from within an end user's computer network, so as to avoid requiring opening firewall ports that otherwise would require opening so that a computer peer located on an outside network could itself initiate such a secure connection. In certain embodiments of the invention, a local user may also choose to form a direct electronic communication connection with the building controller 100 hardware. In other embodiments of the invention, a local user may communicate directly through a local computer network without the use of the internet. Such a connection may be useful in the event that an internet connection is unavailable to the local computer network.

As illustrated in FIG. 2, building components 202 may include, but are not limited to, lighting, refrigeration, climate controls (which may be further divided into heating, cooling, and humidity control), and hot water controls (boilers). Many of these building components 202 may feature computerized control systems themselves. Those building components that utilize computerized controls may have control interfaces that comprise digital communication interfaces. These digital communication interfaces generally take the form of a serial or parallel communications connections interface. The primary difference between the two being the complexity and number of electrical connections between the devices connected by the communications interface. Serial communications methods may be configured for use in a daisy-chain arrangement in order to reduce the amount of connection cable required and thus installation cost. As is illustrated in FIG. 1, an exemplary building controller 100 may comprise one or more internal communications interfaces 112 which implement communication protocols such as RS-485. Exemplary building components may include sensors such as those for temperature and humidity which contain serial communications capabilities. Building components may also include such systems as furnace controls, air conditioner controls, boiler controls, building access controls, and lighting control system where such systems are computerized and may include one or more serial communications interfaces. As will be described later herein, serial and parallel connections generally require configuration to identify the correct communications protocols for devices connected to such interfaces.

Many building systems rely on control wire systems that use contact closure interfaces. In such a system, a mechanical or electronic relay opens or closes a connection to provide a low voltage signal to or from a control system. As is illustrated in FIG. 1, an exemplary embodiment has a plurality of such control wire inputs and outputs 110. An advantage of embodiments of the current invention is that the configuration of these plurality of inputs and outputs may be performed using a cloud-based database and synchronized with a database maintained in the building controller 100. Such a configuration and synchronization will be described later herein.

Embodiments of the invention may be modular in nature, that is, a controller may initially comprise a certain number of control wire inputs and outputs whereupon additional inputs and outputs may be added in anticipation of the need for a greater number of such inputs and outputs. In certain embodiments of the invention, a second control box may be placed in communication with the local computer network. In such an embodiment, the second control box may be configured to act as a slave to the primary control box. In other words, a first control box may control certain operations of a second control box to avoid conflicting operation between the two. The control performed by a master control box may be at a high level such as event scheduling and the presentation of a user interface while lower level functions, such as discrete control of various building systems may be performed by a control box regardless of whether the control box is configured as a master or a slave. Such configurations may be beneficial in implementations which require a larger number of inputs and outputs than may be supported by a single control box. Certain embodiments may be configured to appear as a single control box to a user regardless of how may control boxes are actually used in an implementation. This capability may be used to present a concise user interface such that a user need not be concerned with the actual physical configuration of such an implementation. In order to properly identify and control building systems connected to these inputs and outputs, identifiers must be assigned to the various inputs and outputs. These identifiers can be used to identify the purpose of an input or output both to control software and also for use in a user interface. For example, an input may be used to receive temperature readings from a sensor located in a certain portion of a building. A contact closure or wire control may be used to control a furnace burner and another may be used to control a blower motor in an air handler system. These inputs and outputs may be assigned identifiers which represent their function to a temperature control script (software program). The control script may perform the function of regulating the temperature of a certain portion of a building which involves control of one or more of the identified inputs and outputs.

In addition to the modular nature of the input/output interface portions of a control box, the processor portion of the control box may also be modularized in certain embodiments of the invention. This modularization may comprise the processor 102, memory 104, software programming 106, external communication circuitry 114, and the system database 116. In addition to aiding manufacturing and assembly, such modularization may allow for installed system performance upgrades as improved processors become available and cost effective. In such a manner, an installed system may be upgraded to be compatible with improved technologies as they become available. Other elements of the control box may also be modularized to allow for easy repair or upgrade. An example of such modularity in certain embodiments of the invention may also be communication components such as wireless data. In such embodiments, radio components such as, but not limited to, Wi-Fi, Bluetooth, and cellular data transceivers may be configured as a modular component connected to a printed circuit board or communications interface buss. For example, as illustrated in FIG. 1, the external communications component 114 may be connected to the various other components which comprise the building controller 100. In such an embodiment, a user or other maintenance person may replace or upgrade such components as the communications component without requiring the replacement of the entire circuitry of the building controller 100.

When installed in a building or other structure, the control wires connected between the building controller 100 and various building systems may extend many feet from between the control box and building system being controlled or monitored. These long runs of wire may be susceptible to interference and voltage surges. In order to avoid such susceptibility and resultant control and measurement difficulties or damage, the input and output controls may comprise isolation and surge suppression components. In an exemplary embodiment, such isolation may be provided by an opto-isolator. Other embodiments may implement mechanical isolation such as relays or contactors to provide such isolation. One ordinarily skilled in the art will understand that there are there are various methods of obtaining the necessary isolation and thus, it should be understood that the optical and mechanical methods of isolation described are only exemplary and not intended to be limiting. In addition to isolation, surge suppression may be employed in combination with or separately from the isolation previously described. Examples methods of surge suppression include, but should not be limited to, metal oxide varistors (MOVs), discharge tubes, thyristors, capacitive filters, and inductive filters. As with the processors 102 and communications devices described above, these surge suppressor and isolation devices may be modularized for ease of maintenance and repair.

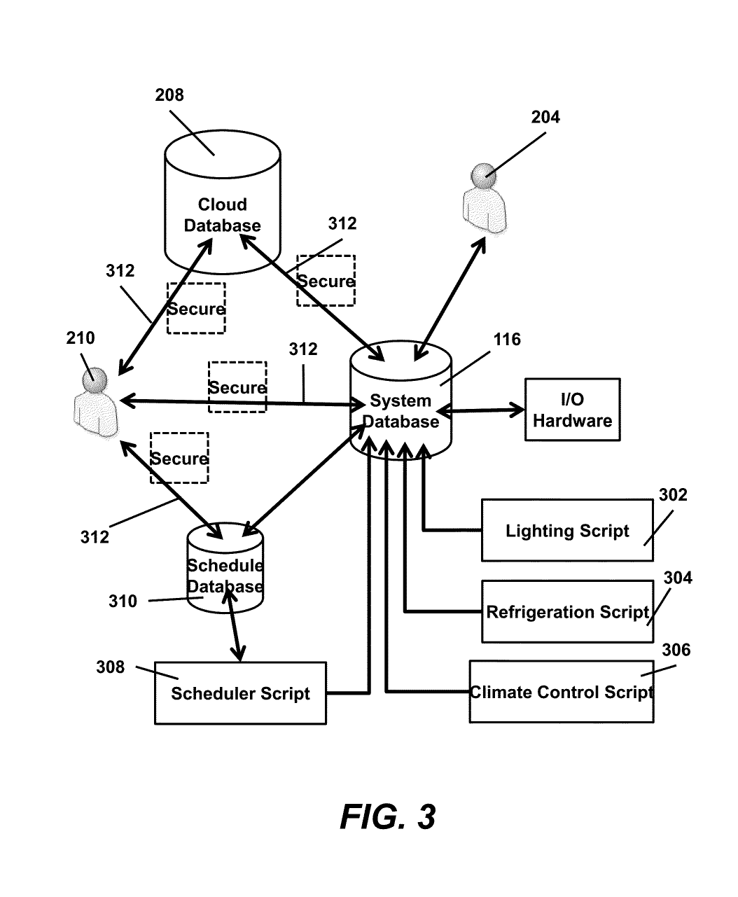

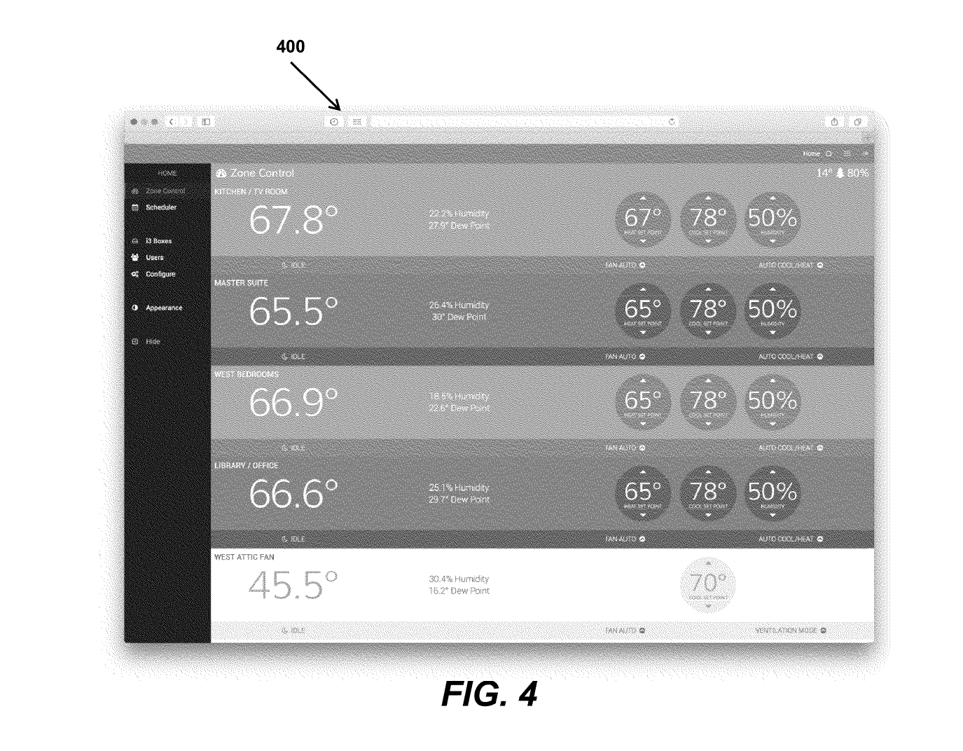

Embodiments of the invention may utilize a plurality of databases to store and synchronize various configuration and data parameters. FIG. 3 illustrates an exemplary configuration of such databases. As is illustrated, a system database 116 may comprise configuration and data parameters used to provide data for various functionalities performed by software programs (referred to herein as “script”s). In addition to identifying inputs, an embodiment of the invention may also comprise a plurality of parameters used in the control process. Examples of such parameters include, but are not limited to, various building condition setpoints, hysteresis values between setpoints, minimum and maximum runtime, minimum break times for individual appliances to prevent “short cycling” which may be damaging for certain building systems, and minimum/maximum setpoints for certain parameters such as temperature. These setpoints may be preselected or may be entered or adjusted by a user via a user interface 400, an example of which is illustrated in FIG. 4. As shown in FIG. 3, a script may perform operations relating to control of building systems including, but not limited to those illustrated. For example, FIG. 3 illustrates a lighting script 302, a refrigeration script 304, and a climate control script 306. These scripts operate on information stored in the system database 116. For example, the system database 116 may comprise a storage location representing the status of a particular lighting circuit within a building. When the storage location changes, the lighting script 302 may perform a series of steps that communicate the change in status to the building system in such a way as to cause the desired result.

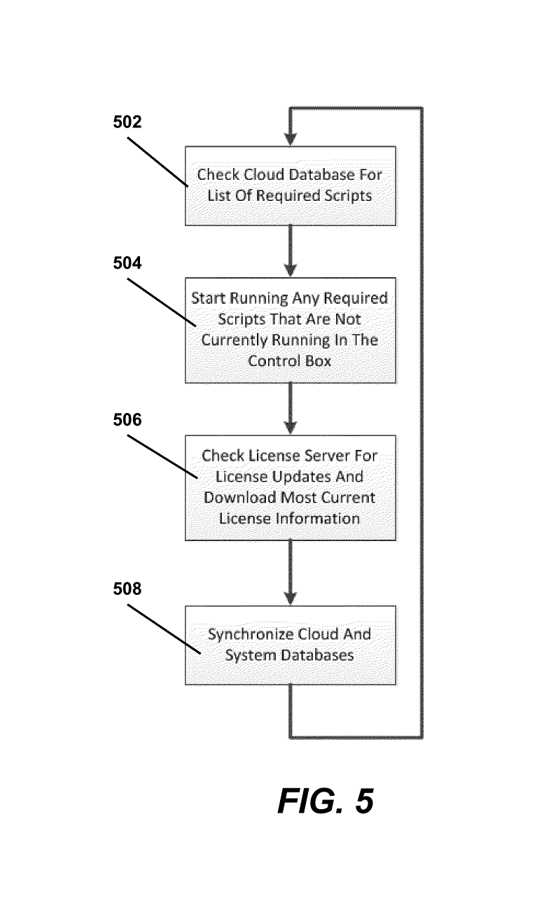

A program script may be used to perform the basic system maintenance functions. FIG. 5 illustrates a simplified example embodiment of such a script. As illustrated in step 502, the script may cause the processor 102 of a building controller 100 to perform functions such as checking the system database 116 to determine which control scripts (heating, cooling, etc.) are required to operate the current configuration of the building management controller. Step 504 causes the processor to start running the identified scripts if they are not already running. Each identified script may function to control a certain building function. For instance, a climate control script will perform steps such as reading a temperature sensor to determine if heating or cooling is required to satisfy a temperature setpoint. Certain embodiments of a climate control script may be configured to control individual functions of a heating or cooling system. In step 506, the maintenance script may check a license server 212 to determine if there are any updates to the control system license. As will be described herein, such a license may be used to require a user to periodically renew their system license. In step 508, the maintenance script may perform a synchronization process to keep the system database 116 and a cloud database 208 synchronized.

In addition to the scripts related to building systems, embodiments of the invention may utilize an additional script to control time-based control functions. Time-based control functions may be used to control building system operational characteristics with regard to a date and time. For example, an embodiment of the invention may change the temperature setpoints in an office building to match the expected use of certain areas by employees or guest at various times during the week. For example, an office area may be maintained at 69 degrees during a normal work week and allowed to drop to 63 degrees during the weekend. In another example, a call center area located in a different part of the building may be occupied 24 hours per day and as such, may be maintained at 69 degrees constantly. In order to manage a time-based operation, a scheduler script 308 may be used. This script may communicate with the system database 116 to change setpoints according to a predetermined time schedule. In an embodiment of the invention, such a time schedule may be contained in a scheduler database 310. Such a database may be a separate database as illustrated in FIG. 3, or it may be a component of the data stored within a system database 116. In an embodiment of the invention, the scheduler script 308 may retrieve scheduled events or system changes from the scheduler database 310 and communicate those changes to the appropriate data locations in the system database 116 to cause changes in building systems according to the desired schedule of events contained in the scheduler database.

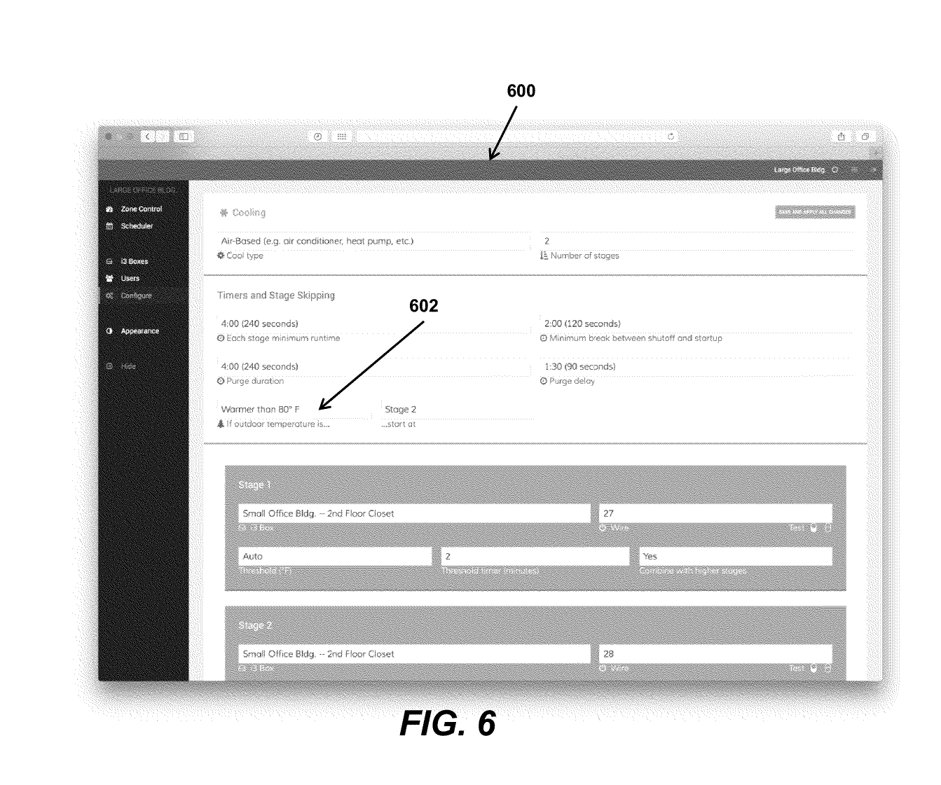

Embodiments of the invention may also use the system database 116 to configure functions of the building controller 100. In particular, the I/O hardware (110 and 112) may be configured such that control wire inputs and outputs may be associated with their intended control function. For example, a relay output circuit 118 may be associated with a fan control contactor (not illustrated) that causes a fan motor to be energized. The system database 116 may associate this fan with a climate control system and control the fan as a component of that system. In such a manner, discrete components may be combined by function such that a timer or user input may be dedicated to a high level function such as increasing the temperature of a portion of the building. The high level function may execute a script function to control the temperature within a building. The temperature control script may operate at a high level such as a simple signal to turn on or off a furnace. In other embodiments, a script may operate at a lower level of control. The main difference between a high and low level script function is that the high level script requires that the building system (for example, a furnace) will have the necessary functionality to operate from a simple on/off control signal. Whereas, a low level control script may access sub-functions that when taken as a whole, perform the functions of the building system. For example, a high level script may send a signal to a furnace that causes the furnace to engage a heating element and blower motor to provide warm air. A low level script may send a signal turn on a heating element, sense the temperature of the heating element, and when the temperature is high enough, send a second signal to turn on an air circulation fan to provide warm air. Certain embodiments of the invention may allow for a plurality of heating elements to be controlled. In such an embodiment, heating elements can be activated incrementally as conditions dictate. Such an incremental action may reduce cost by reducing peak energy demands (and thus, costs) that may occur if a single large heating element were used. Such a configuration is referred to as a staged system. FIG. 6 illustrates a user interface with a multi-stage cooling configuration 600. 602 illustrates a setpoint which enables a second stage of cooling.

In certain embodiments of the invention, supplemental devices may be added and controlled using the building control system in a manner that is integrated with the control of an existing building system. For example, a common occurrence is a situation in which a portion of a building may not be able to be heated or cooled adequately by an existing climate control system. Embodiments of the current invention may be configured to control an existing climate control system and also a supplemental heater or cooler dedicated to the portion not adequately heated or cooled by the existing system. A climate control script may activate the existing climate control system and if needed, activate the supplemental heater or cooler to provide additional heating or cooling needed to regulate that portion of the building. The use of such an embodiment may greatly reduce the cost to a user by regulating the previously inadequately heated or cooled building portion without the requirement of increasing the capacity of the existing climate control system.

Because the control functions of the building controller 100 are implemented using software scripts, additional features and functions may be added to the control box through the implementation of additional software scripts. These scripts may be communicated to the building controller 100 during a synchronization process. In such a manner, additional building systems may be added to implementations of the invention without the need for hardware replacement or upgrades. Example systems might comprise new heating and cooling technologies, energy generation and storage (for example, a solar array), and improvements to the control processes used to manage existing building systems. Another example may be improved communications security as new security standards are introduced. Using this capability, embodiments of the invention may be quickly reconfigured to accommodate new building configurations such as a shift from a boiler system to a forced air system as a building undergoes renovation.

In embodiments of the invention, building controller 100 input and output hardware (110 and 112) may be configured and reconfigured by changing configuration information stored in the system database 116. In addition to control wire inputs and outputs 108, internal I/O functions may be configured using the system database 116. For example, in an embodiment which includes a RS-485 serial communications port, the system database 116 may comprise information that selects communication characteristics of the serial communication port. Because the configuration characteristics of the building controller 100 are contained in the system database 116, system configuration may be revised by changing the data housed in the system database. As is illustrated, a local user 204 may be in communication with the system database. By using such communication access, the local user 204 or remote user 210 may view the status of building devices in communication with the building controller 100. An embodiment of the invention may be configured to allow a local user to interact with the control box through an internet connection, appearing to the control box as if that local user were remotely located. The local user 204 may also be able to change the operating status of controlled building devices by modifying setpoint data contained within the system database 116. As is illustrated in FIG. 3, the local user 204 may communicate directly with system database 116 using a local display interface or indicators or may communicate with the system database using a computer network connection. Access to the database may be securing using security measures including but not limited to, username and password, hardware key devices, and software key devices.

A remote user 210 may also be in communication with the system database 116 of a building controller 100. As illustrated in FIGS. 2 and 3, such a user may be located on a wide area network such as the internet 214. In order to provide a secure connection 312, technologies such as VPN or other tunneling techniques may be used. As with a local user 204, embodiments of the invention may utilize security measures including but not limited to, username and password, hardware key devices, and software key devices. In an embodiment of the invention, communications between users and databases located remotely from a building controller 100 may be performed using a secure shell (SSH) tunnel that is active whenever access to the internet is available to the control box. Such a SSH tunnel connection may be configured to automatically reconnect after a period of interruption. A SSH tunnel configuration has the advantage of not requiring modifications to an existing firewall configuration at a user building site. Additionally, such a configuration will function to limit commands received by the building controller 100 to those from trusted sources.

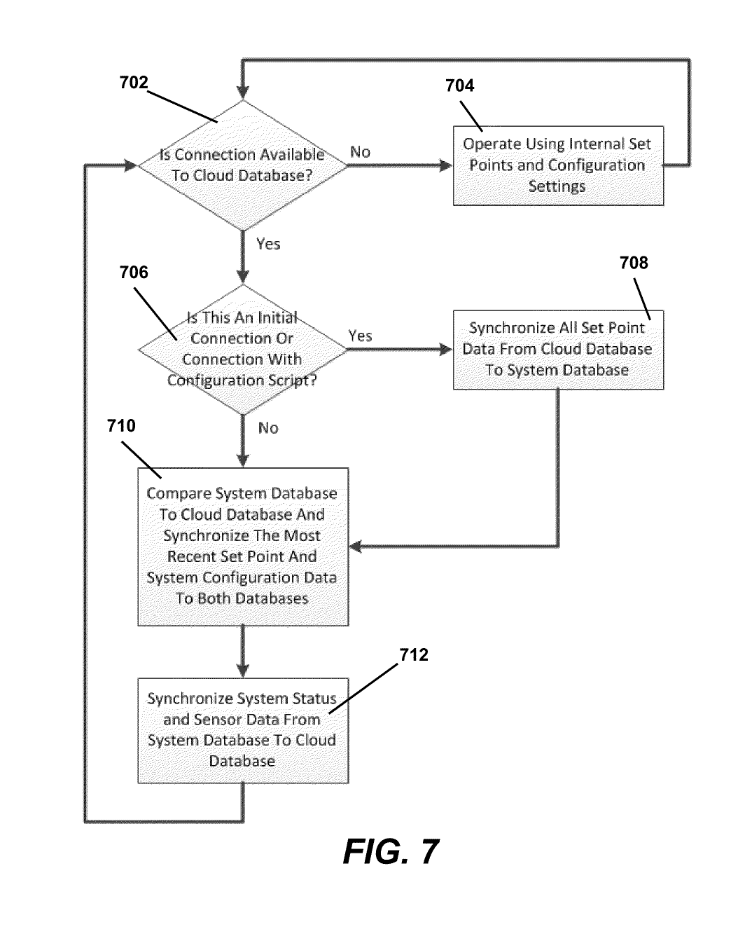

As is illustrated in FIG. 3, an embodiment of the invention may be configured to comprise a cloud database 208. This cloud database may be used to synchronize with the system database 116 of a building controller 100. As the result of such synchronization, the cloud database may be used to allow a user to configure a building controller 100 even before the control box has been installed or connected to a wide area network. An example embodiment of a synchronization process is illustrated in FIG. 7. In step 702, a building controller 100 performing the synchronization process checks to determine if there is a communication connection to a cloud database 208. If no connection is found, the controller continues to operate using internal setpoints and configuration settings found in the system database 116 as illustrated in step 704. In step 706, the controller determines if the communications connection is an initial connection or a connection to a configuration program script. If so, in step 708 the controller retrieves setpoints and configuration information from the connected cloud database to initially configure or reconfigure the building controller 100. If not an initial configuration or reconfiguration, the controller performs step 710 which compares the system and cloud databases and synchronized the most recent setpoints and configuration data to both databases. In step 712, the controller synchronizes the system status and configuration data from the system database to the cloud database to allow remote users to review controller system and sensor status. In embodiments of the invention this synchronization of system status data to the cloud database 208 may allow a remote user 210 to check the last synchronized system status even if communication between the cloud database and the system database is unavailable. Additionally, the remote user 210 may make changes to the system setpoints stored in the cloud database 208 which will be synchronized with system database 116 when communications are restored. In such a manner, a remote user 210 may be able to perform system maintenance and configuration even at times when communications access to the building controller 100 is unavailable.

Known building control systems may require configuration at the time of installation or initial system start-up. As a result, a technician or other highly skilled individual may be required to visit the site of the system installation. Using a configuration software tool, a user may select setpoints and other configurations for a control box using the cloud database 208 and then cause the setpoints and configurations to be synchronized with the system database 116 when the building controller 100 is installed for use. In such an embodiment of the invention, a programmer, installer, or user may use cloud database 208 to preselect setpoints and other configuration settings in the cloud database. These setpoints and settings may then be uploaded to the system database 116 once the building controller 100 is installed. The result may be a more efficient use of a specialized resource like a programmer without impacting the installation schedule of the control box, which may be dependent upon a builder, remodeler, or electrician.

Referring again to FIG. 3, a scheduler database 310 may be used by a scheduler script 308 to change the time-based operation of the building controller 100. As with the system database 116, the scheduler database 310 may also be modified by either a local 204 or remote user 210. The local user may access and modify the scheduler database in a manner similar to how that user would access the system database 116. For example, a user wishing to add or modify a time-based event could log into the building controller 100 using a user name and password. Once authenticated, a user may be able to add, view, or change time-based events in the scheduler database. Similarly, a remote user 210 may be able to connect to the scheduler database using a secure connection 312 and add, view, or change time based events in the scheduler database.

As was discussed above, a remote user 210, programmer, or installer may be able to preconfigure a building controller 100 using a cloud database that may later be synchronized with the system database 116 to transfer setpoints and other data to the system database of a building controller 100. In certain embodiments of the invention, the remote user 210 may connect directly to the system database however, in circumstances in which the remote user is unable to connect to the system database; the remote user may be directed instead to the cloud database 208. As the result of an ongoing synchronization process, the cloud database may closely reflect the data contained in the system database. Thus, the remote user may be able to review data in a cloud database that reflects the control box status as of the most recent synchronization between the control and cloud databases. In a manner similar to pre-configuration of a yet to be installed building controller 100, a remote user may be able to make changes to the operating characteristics stored in the cloud database and have those changes transferred to the system database when the cloud database next synchronizes with the system database.

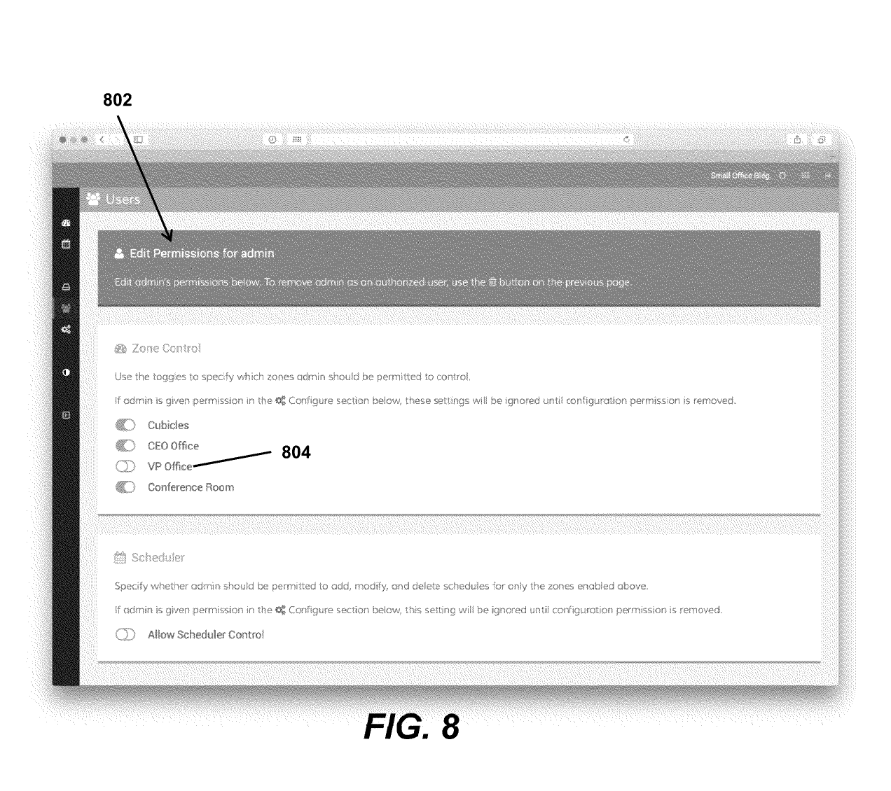

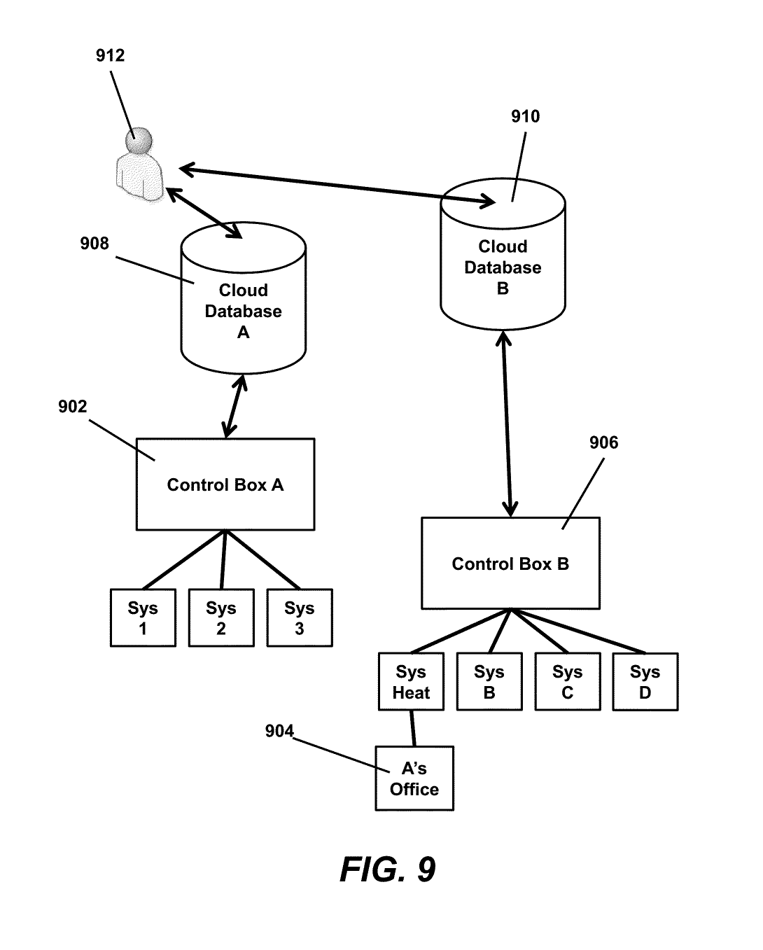

Embodiments of the invention may be configured to allow a user associated with one control box to have access to one or more additional control boxes. This access may be configured such that the user may have limited access to the additional control boxes. In certain embodiments of the invention, the limitations may be such that the user may only view system database information. In other embodiments, a user may have the ability to access and control a limited portion of the building systems associated with the additional control box. A user management function may be used to select permissions for a particular user or classification of users. As illustrated in the example user interface shown in FIG. 8, permissions for a user may be selected 802. For example, a user group identified as “admin” is provided with control over the zone identified as “VP Office” 804. As is illustrated in FIG. 9, a user may have unlimited access to a first building controller 902 located in that user's home and may also be granted access to control the temperature in the users office 904 using a second building controller 906. As is illustrated in the figure, a first cloud database 908 is in communication with the first control box 902. A second cloud database 910 is in communication with the second control box 906. In the illustrated example, a user 912 is in communication with the first control box 902, the first cloud database 908, and the second cloud database 910. In such an embodiment, the cloud databases are located remotely from their associated control boxes. Such an arrangement allows the user 912 to be provided access to the second database without the need to grant that user access to the computer network upon which the second control box is located or the user account that specifically administers the second control box. The user's access to the second cloud database may be limited as described above, to only that data which represent the temperature of the user's office 904. In addition to being limited to certain portions of the second control box, the user may also be limited in his or her ability to vary parameters of the second control box. For example, a user may have access to control the temperature of that user's office but such control may be limited to a certain range (i.e. 62-73 degrees) to avoid damage to building systems or contents.

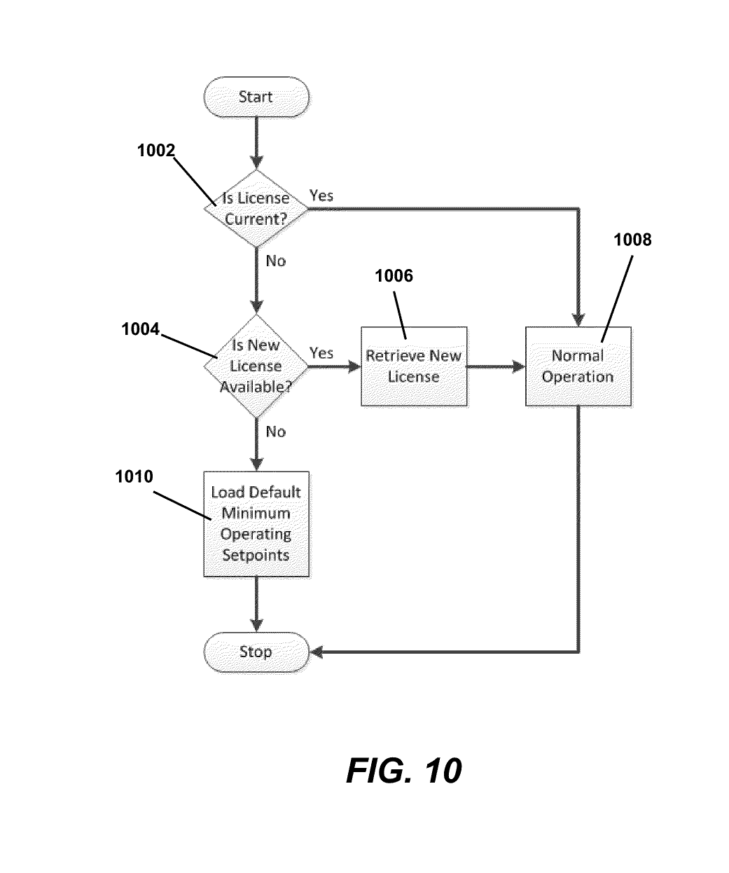

One of the barriers faced by those responsible for the cost of building or maintaining a house or building is the cost of purchasing, installing, and maintaining building control systems. Leasing building control system equipment is a known method of mitigating these costs. Unfortunately, the party who owns the equipment (the lessor) may find it difficult to manage such a lease in the event that the party responsible for making lease payments (the lessee) fails to make their lease payments in a timely manner. In such a case, the building management systems are frequently installed in the lessee's property and not easily accessed by the lessor's agents. In certain embodiments of the current invention, an implementation may additionally comprise a license server. An illustration of such an embodiment is shown in FIG. 2. A license server 212 may be in communication with a building controller 100 through the use of a wide area network such as the internet 214. In such an embodiment, the building controller 100 may periodically contact the license server 212 for an updated license code. In the event that a lessee has failed to make the required lease payments, the server may be instructed to refuse to provide a license code to the building controller 100 requesting the license. As illustrated in FIG. 10, a building controller 100 may determine that its license code is no longer current 1002. The building controller 100 may attempt to contact a license server 212 to determine if a new license code has been made available 1004. If such a code is available, the new license code may be retrieved 1006 and the controller may continued to operate normally 1008. If a new code is not available, the building controller 100 may revert to minimum safe operating levels for controlled building systems 1010. Such minimum safe operating levels may be contained in the system control scripts described above. The reversion to these levels may allow a building control system to operate at levels sufficient to avoid damage but may be less than optimal from the standpoint of energy efficiency or occupant comfort. Certain embodiments of the invention may include “grace periods” during which the building control system may still operate normally without a valid license code. These grace periods may allow for uninterrupted building control operation in the event of a wide area network failure or other temporary loss of communication.

As was described above, embodiments of the invention may utilize timing and staged heating and cooling functions to limit peak energy demand. Because utilities frequently provide discounted rates for customers who can limit their peak demand. Utilities also may also offer tiered energy rates based on demand level and time of day. Embodiments of the invention may implement energy consumption optimization scripts. These scripts may communicate with utility providers using interfaces such as application programming interfaces (APIs) to retrieve peak usage discount data. An embodiment of such an optimization script may utilize discount data to adjust peak energy usage based on current rates provided by utilities. Such an embodiment may provide greater energy savings than systems based solely on time of day limitations.

Any embodiment of the present invention may include any of the optional or preferred features of the other embodiments of the present invention. The exemplary embodiments herein disclosed are not intended to be exhaustive or to unnecessarily limit the scope of the invention. The exemplary embodiments were chosen and described in order to explain the principles of the present invention so that others skilled in the art may practice the invention. Having shown and described exemplary embodiments of the present invention, those skilled in the art will realize that many variations and modifications may be made to the described invention. Many of those variations and modifications will provide the same result and fall within the spirit of the claimed invention. It is the intention, therefore, to limit the invention only as indicated by the scope of the claims.

What is claimed is:

1. A building control system comprising:
a first database in electronic communication with a first building controller;
the first building controller comprising:
a processor;
a second database;
a memory;
a communications interface;
a plurality of input/output connections; and
software instructions which when executed cause the processor to:
retrieve building device control data from the second database;
configure at least one of the plurality of input/output connections using the retrieved data to control a building system in electrical communication with the at least one input/output connection; and
synchronize data between the first database and the second database.

2. The system of claim 1, wherein the first database comprises controller configuration data and building device control data.

3. The system of claim 1, wherein the electronic communication between the first database and the controller is conducted over a computer network which comprises a wide area network.

4. The system of claim 3, further comprising a user interface which displays building status data retrieved from the first database.

5. The system of claim 4, wherein the user interface is configured to receive information from a user for communication to the first building controller.

6. The system of claim 1, further comprising a second building controller in electronic communication with the first database.

7. The system of claim 6, further comprising a user interface which displays building status data from the first database wherein such data comprises building status information obtained from the second building controller.

8. The system of claim 7, wherein the user interface is configured to receive information from a user for communication to the second building controller.

9. The system of claim 1, further comprising:
a license database in electronic communication with the first building controller; and
software instructions which when executed cause the first building controller to set at least one input/output connection to a predetermined default state unless a valid license code is stored in the license database.

10. A method of configuring a building control system comprising the steps of:
receiving at a first database, data representing configuration settings for a building controller;
causing the building controller to be in electronic communication with the first database;
receiving at the building controller data representing the configuration settings of the building controller from the first database;
storing the received building controller data into a second database; and
executing software instructions to cause a processor to:
retrieving building controller data from the second database; and
configuring at least one building controller interface circuit using the retrieved building controller data.

11. The method of claim 10, wherein the data representing configuration settings comprises:
data corresponding to the configuration of a plurality of building controller inputs; and
data corresponding to the configuration of a plurality of building controller outputs.

12. The method of claim 10, wherein the data representing configuration settings comprises data corresponding to a plurality of building condition setpoints.

13. A method of controlling building systems comprising the steps of:
configuring a building controller comprising output circuitry to be in electrical communication with a plurality of building systems;
configuring the building controller to be in electronic communication with a wide area network;
receiving at a processor located within the controller, controller configuration data from a first database;
receiving at the processor, building system state data from the first database;
causing at least one building controller output circuit to provide a signal to a building system where such signal is intended cause the building system to change state to correspond to the building system state data from the first database; and
synchronizing controller configuration and building state data between the first database and a second database.

14. The method of claim 13, further comprising the steps of:
receiving at the processor from the first database, building system state data corresponding to predetermined time periods;
receiving at the processor, data corresponding to a then current time; and
executing software instructions which cause the processor to instruct at least one output circuit to change state according to the building system state data with predetermined time periods that correspond to the received then current time data.

15. The method of claim 13, further comprising the step of requesting by the building controller, a license code from a license code server.

16. The method of claim 15, further comprising the step of configuring the building state data in the first database to a predetermined default state if a valid license code is not received by the building controller.
